(19) United States
(12) Patent Application Publication
(10) Pub. No.: US 2019/0132440 A1
(43) Pub. Date: May 2, 2019

(54) A Box to Improve User Focus

(71) Applicant: Saent Holding Ltd., Wanchai (HK)

(72) Inventors: Russell Haines, Sunnybrook, Rotorua (NZ); Tim Metz, Hong Kong (HK); Joshua Catone, Cranston, RI (US)

(73) Assignee: Saent Holding Ltd., Wanchai (HK)

(21) Appl. No.: 16/095,686

(22) PCT Filed: Apr. 24, 2017
(86) PCT No.: PCT/US17/29219

§ 371 Date: Oct. 22, 2018

Related U.S. Application Data
(60) Provisional application No. 62/327,398, filed on Apr. 25, 2016.

(51) Int. Cl. H04M 1/725; G06F 9/54; H04W 4/80

(52) U.S. Cl. CPC H04M 1/72577; H04W 4/80; G06F 9/542

(57) ABSTRACT

A box to encourage a user not to use a mobile device comprising a space to receive the mobile device, a communication logic and wireless technology, selected from near field communication technology (NFC) and personal area network (PAN) technology, to establish a communication between the mobile device and the box, a blocking mechanism to block the mobile device from alerting the user, wherein a time the mobile device is in the box is logged.

### RELATED APPLICATIONS

The present application claims priority to U.S. Provisional Application No. 62/327,398 filed Apr. 25, 2016 and incorporates that application in its entirety, and is a National Stage filing of PCT/US17/29219 filed on Apr. 24, 2017, which filing is also incorporated in its entirety.

### FIELD

The present invention relates to a box to assist with mobile device addiction and focus.

### BACKGROUND

Mobile devices are addictive. People compulsively check their mobile phones for new messages, for games, for news, and for other reasons. Similarly, mobile gaming systems, music systems, and other mobile devices can become addictive to their users. Such constant interruption makes users less focused, which makes them more stressed, and generally reduces their quality of life.

There has been a lot of recent research discussing the addictiveness of mobile devices, but beyond self-control there are not many solutions that address this issue.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is a network diagram showing one embodiment of the various elements that may be present in the system.

FIG. 2 is a block diagram of one embodiment of the Box and a mobile device.

FIG. 3A is a flowchart of one embodiment of using the Box.

FIG. 3B is a flowchart of one embodiment of the application connectivity, which creates sessions.

FIG. 4 is a flowchart of one embodiment of configuring the Box features, with and without the Box.

FIG. 5A is a diagram of one embodiment of a Box.

FIG. 5B is a diagram of another embodiment of a Box.

FIG. 5C and 5D illustrate use cases for one embodiment of the Box.

FIG. 5E illustrates the positioning of a sensor for the Box.

FIG. 6A-G are user interface figures of embodiments of an application associated with the Box.

FIG. 7 is a block diagram of a computer system which may be used with the present invention.

### DETAILED DESCRIPTION

The Box may be any enclosure or object capable of housing a mobile device. The Box in one embodiment, is a wooden (or other material) box (enclosure) to store one or more mobile devices. It may include sides and a top, in one embodiment. In one embodiment, the box also includes a bottom. When a mobile device is in the Box, it sets itself to a “focus state” which in one embodiment includes silent mode (turn off, turn down volume, turn on Do Not Disturb mode and/or turn on airplane mode) the device through hardware (signal-blocking material in inside of The Box, Faraday cage, etc.) and/or through software. In one embodiment, the Box triggers a silencing feature or application in the device as soon as the user places the device inside The Box. Although the item is referred to as the Box, it may be made of soft material, rather than a rigid box. The term “mobile device” may refer to a cellular telephone, personal gaming device, virtual reality headset, MP3 player, phablet, tablet, or other mobile device with which a user engages and which is a distraction from the user's focus.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

In one embodiment, the placement of the device inside the Box is detected utilizing a sensor, which may be one or more of NFC reader, camera, proximity sensor, light sensor, wireless connection, Bluetooth connection, or alternative method of detecting that the device is inside the box. In one embodiment, the sensor in the Box triggers a software application which then ensures that the mobile device is set to a “focus” state.

In embodiments, The Box might also wirelessly charge the mobile device(s) that have wireless charging capability. In one embodiment, the Box may include a battery to enable it to charge devices. In one embodiment, the Box may be plugged in, and charge in that way.

In one embodiment, the Box may also update, improve, analyze, clean, debug, virus scan, defrag, organize, back up, or even repair the device when inside The Box. In one embodiment, the Box may initiate an application on the phone, which provides these features. In one embodiment, this application may be automatically updated with current data such as current virus signatures, when the phone is placed in the Box.

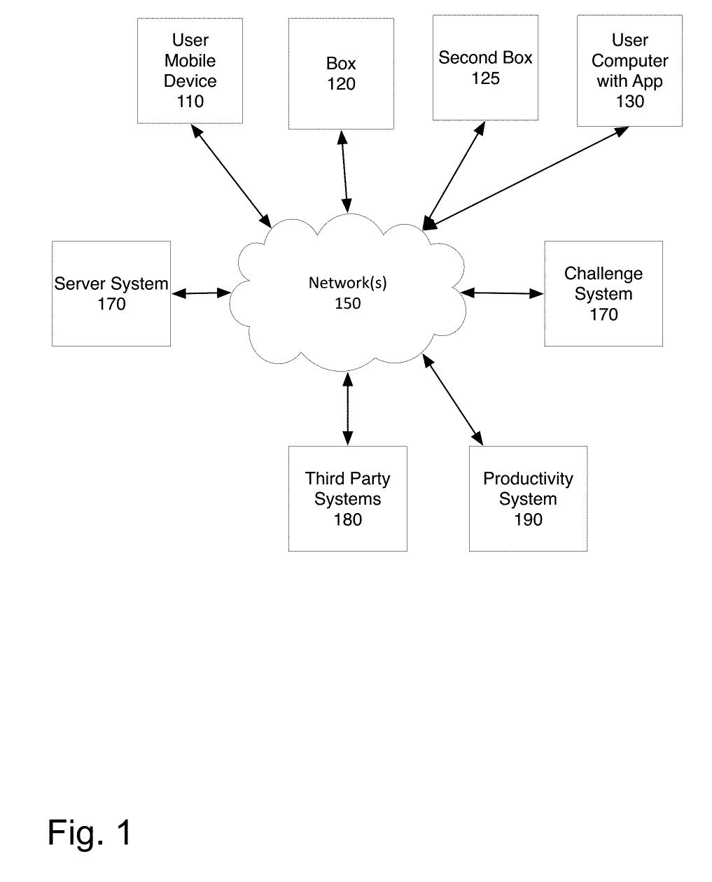

FIG. 1 illustrates a block diagram of one embodiment of the overview of the system. The Box 120 may have a network connection to network 150. The user mobile device 110 is designed to be placed in Box 120. Note that while only a single device 110 is illustrated, the Box 120 in one embodiment may receive multiple phones. For example, at a dinner, everyone dining together may utilize a single Box.

Mobile device 110 can generally access network 150, however in one embodiment when the mobile device 110 is in Box 120, it cannot access the network 150. In another embodiment, the mobile device 110 could access the network, however an application running on the mobile device prevents it from doing so, or from sending notifications, except under some circumstances as discussed below.

In one embodiment, there may be a second Box 125, which is utilized by another person. The second box 125 may also be a second box 125 used by the same user, in a different location (e.g. home and work). The server system 160 in one embodiment may enable users to share Box data between Boxes 120, 125. In another embodiment, if the Boxes 120, 125 are in proximity, they may communicate peer-to-peer rather than through server system 160. In one embodiment, the user may also have a computer application 130, which enables the user to track his or her utilization of the Box 120, 125. Server system 160 in one embodiment, enables the data collection and data analytics.

In one embodiment, the system may further interface with a challenge system 170 which enables users to perform self-challenges, team challenges, or be challenged by someone they are connected to with a Box application. Challenges are competitions, in which, in some embodiments prizes or bragging rights may be obtained. The system may allow the user, or a third party, to set a challenge and reward before the phone is placed a Box. If the user completes the challenge (i.e. Leave your phone in the box for 30 min) they will be rewarded with points, or some other incentive. Using the various inputs and sensors build into all phones the system will be able to judge if the user has used their phone. For example, when going out to dinner with friends, the challenge may be set to not touch the devices until dinner is over. This can encourage friendly conversation, instead of using individual devices in a shared setting.

In one embodiment, there may be a third party system 180 to which the Box 120, 125 may interface. The third party system 180 in one embodiment may enable locations or businesses to offer rewards for the use of a Box. For example, The Box (and mobile app) could connect to other third party objects and systems 180 as well, such as point of sales systems in a restaurant. This may enable, for example, a restaurants to provide a Box and give customers a discount if they keep their phones in the Box. For example, a coffee shop may provide a discount if users utilize a Box, and interact with each other instead of hiding behind their mobile devices.

In one embodiment, the Box 120, 125 and/or mobile app on user mobile device 110 may also interface with a productivity system 190. Productivity system 190 may be the Button described in co-pending application PCT/US2016/041198 filed on Jul. 6, 2016, which is incorporated herein by reference. In one embodiment, the Box 120 (and mobile app) collects data on device usage and user behavior. This can be provided to the Productivity system 190. The Productivity system 190 may be used to help improve the user's attention, productivity, and habits. It is known that focused time, in which the user is not distracted is more productive. By reinforcing and rewarding such focused time, the system improves the user's attention, productivity and habits.

In one embodiment, interplay between the Button and the Box enhances both. In one embodiment, the Box and productivity system 190 may enable the user's device or button to provide additional functionality. For example, if the user puts their phone 110 in the Box 120 before they go to sleep, then they cannot use the phone as an alarm clock. However, the Button of the productivity system 190, in one embodiment, has a timing chip, so the button could be used as an alarm clock, if the system detects that the phone 110 is in the Box 120 but an alarm is set. As another example, if the user puts their phone in the Box for a specific amount of time (a session), the button could be associated with the Box, or may even be placed on top of the Box, and show (through the LED halo) how long the box session will last.

In one embodiment, when the mobile device connects to the Box via the NFC or other connection, the mobile device is configured to silent mode, or airplane mode automatically, so that the user can have a focus session, and is not distracted. This requires control of the operating system, or the ability to initiate a particular application, in one embodiment.

In one embodiment, an application is automatically initiated when the user places the mobile device in the Box. In another embodiment, the user manually activates an application, which controls the mobile device, to enable it to remain silent, and not disturb the user during a focus session. In one embodiment, the Box provides a Bluetooth microphone link for the mobile device, so that the mobile device utilizes the link for alerting the user. This enables the Box to effectively mute the device, without requiring interaction or control of the operating system.

In one embodiment, each Box has a unique identifier associated with it, so that the system can track which Box is being used by the user. The Box and mobile device communicate with an associated mobile application and optionally with the central software platform, or an application on the user's computer system. In one embodiment, when the device enters and exits The Box this data is sent to the server or mobile application. In one embodiment, the Box communicates with the server, in another embodiment, the mobile device communicates with the server. In one embodiment, the start and the duration of each “stay” within The Box is sent to the application. This allows the user to track the use of The Box.

In one embodiment, the system allows the user to receive rewards (e.g., points in the app or central platform, a bonus from their boss, a discount in a participating restaurant, and so on) for using the Box, and thus not interacting with, or “disconnecting” from the mobile device. In one embodiment, there may be “challenges” (assignments) within the mobile app, software platform, third party services, enterprises, etc. For example, challenges or goals may include “don't check your device after 9 pm” (improves sleep quality), “be more mindful during dinner” (improves family relationships), and so on.

In one embodiment, the Box may post status messages to the user's social media. In one embodiment, the mobile device may post a status message to the user's social media. A status message may indicate that the user is in a focus session, or brag about the focus session(s) that the user had that day, and/or their Box use. Such posting is controlled by the user's preference settings, in one embodiment. For example, the user may authorize the system to post to social media when the user has achieved a particular goal, started or completed a particular challenge, etc.

In one embodiment, the Box may include a user interface to provide feedback when the mobile device is in the Box. In one embodiment, the user interface may provide feedback about the Box use of other users with whom the user is connected. In one embodiment, users may challenge each other to concurrently use the Box.

In one embodiment, in a business setting, an entire group may agree to concurrently use individual Boxes, or a Box which is shared between the users. This encourages everyone to utilize the Box, since they are less concerned about missing messages from friends or coworkers. In one embodiment, the user may tag a “Box” session in the interface, to indicate what he or she was doing during the time that the mobile device was in the Box. In one embodiment, the tag may include a qualitative tag, indicating how efficient, happy, or productive the user was during the time. In one embodiment, the system may provide a chart of the user's interaction with the Box over the day, work week, week, month, etc.

In one embodiment, the Box notifies the application to turn the mobile device to a Do Not Disturb setting. In one embodiment, the application may be manually initiated by the user, and may automatically interact with the Box thereafter.

In one embodiment, when the user receives a call that is blocked by the Box, the application may notify the server system of the message. The server may respond to the associate who attempted to contact the user, via a text message, email, or other mechanism. This enables the user to respond to contacts, without being interrupted, and even if their mobile device is in the Box, and all signal is blocked, such as when the mobile device is off, in airplane mode, or within a Faraday cage of the Box. In one embodiment, the user may be able to set one or more “override” numbers, for emergency contacts.

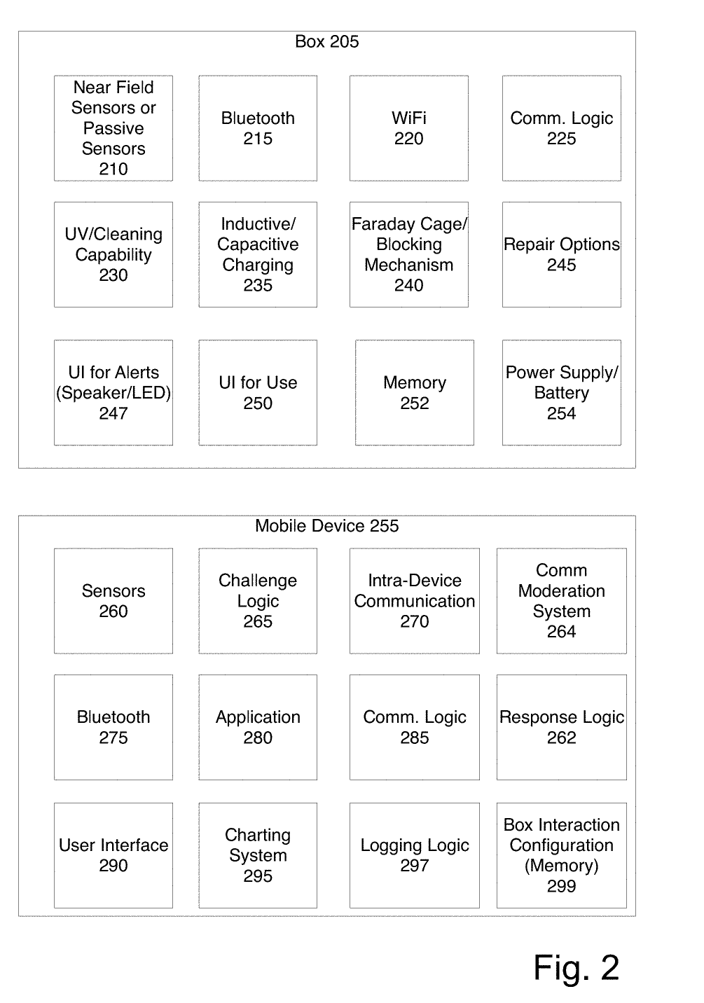

FIG. 2 illustrates the Box 205, and associated mobile device 255. In one embodiment, the Box contains an NFC/RFID chip or other passive or active wireless technology 210. The Box also includes a mechanism that registers when the device is in The Box and when it gets taken out. This may be the NFC or RFID chip, a wireless sensor, a proximity sensor, or another type of sensor. In one embodiment, this sensor may be in the Box, or on the user's mobile device. Detecting this triggers an event, which logs when the device enters and exits The Box, in one embodiment in memory 252. In one embodiment, this may be done on the mobile device, within the Box, or on a server.

The Box includes one or more communication methods, which may include including passive sensors 210, Bluetooth (nearfield wireless) 215, WiFi 220. Communication logic 225 enables the box to communicate with the mobile device 255 and/or server (not shown). The communication logic, in combination with a wireless technology such as a near-field communication technology (NFC) or personal area network technology (such as Bluetooth) is used to establish such communication. In one embodiment, the Box communicates directly with an application on the mobile device.

In one embodiment, the Box 205 includes a faraday cage 240, or other blocking mechanism to block signals. The blocking mechanism limits, or moderates, the outgoing signals the mobile device creates. In one embodiment, rather than using blocking within the Box 205, the application on the mobile device moderates the mobile device functions, such as messaging (SMS/MMS), notifications, phone calls, etc. In one embodiment, mobile device functions may also include interactions with third party applications. In one embodiment, the user may set a default response, using response logic 262. The default response may be “I am in a focus box session, and will get back to you later,” or the like. In one embodiment, the user may further set one of a variety of responses, based on the individual party in question. In one embodiment, different responses may be set for each session, and may be set for various individuals, or groups. For example, the boss may override a session at any time, but if the user is expecting an important call from their bank they may set their bank's number as an override number, for a particular session. In one embodiment, such overrides may alert the user, on the box using a box UI, on the user's mobile device (allowing it to ring or otherwise create notice), or on the user's associated computer or other device.

Some of the features that may be implemented by embodiments of the Box 205 include UV/cleaning capability 230, inductive/capacitive charging 235, repair options 245. UV/cleaning utilizes UV or other radiation that is not harmful to the device to clean germs off the device. It may also include a material which physically cleans the screen. Inductive/capacitive charging 235 may enable a mobile device which includes such capability to be charged. Repair options 245 may provide operating system or application updates, or other repairs. The box in 205 in one embodiment has a processor. The box includes a power supply/batter 254. In one embodiment, the box is designed to be portable, with a batter 254 which is designed to last for many weeks before needing recharging.

The mobile device 255 may include sensors 260 as well as user interface 290 systems. Communication may use intra-device communication 270, Bluetooth or other local area or personal area networks 275, and communication logic 285. In one embodiment, the mobile device 255 may include a Box interaction configuration 299, which configures the mobile device 255 when it is placed in the Box.

In one embodiment, communication moderation system 264 moderates core functions of the mobile device including messaging (SMS/MMS), notifications, phone, etc. In one embodiment, when the application is installed, it requests and is granted admin status. This enables the application to access the device's core functions and third party applications. Thus, the application is able to moderate the behaviors of the mobile device. In another embodiment, the system may utilize a personal area network connection, such as Bluetooth, between the Box and an active application on the mobile device to moderate the device functions. By diverting notifications and messages, the user can be kept from distraction, without requiring direct access to the device core functions.

Challenge logic 265 enables the mobile device and/or Box to receive and complete challenges and associated awards and/or rewards.

In one embodiment, the mobile device 255 has an application 280 which implements these features, including a logging logic 296 to log how much time the mobile device is in the box 210. In one embodiment, this uses the internal clock of the mobile device. In another embodiment, this may be done by the server, or by the Box. In one embodiment, charting system 295 charts the user's productivity and box use. In one embodiment, charting system 295 also provides the user's success rate in competitions.

In one embodiment, this information can then be used to trigger subsequent “events” (e.g., rewards, challenges) within the mobile app, as well as in other devices and applications within the ecosystem (incl. the central software platform). In one embodiment, the user can set what should be triggered when the device goes into The Box (e.g., “Do not Disturb”, “airplane mode”, etc.). In one embodiment, when the device is in the Box, someone who attempts to contact the user may receive a message, such as “I am currently in a focus session, but will get back to you shortly.” In one embodiment, the message may provide an estimated time when the user will likely come out of the session. In one embodiment, the user may specify special contacts, who can interrupt a focus session, even when the device is in the Box. For such contacts, the Box may alert the user, via a user interface 246, such as an LED or speaker. The user may choose to end the session, and respond to the contact, or may choose to continue it.

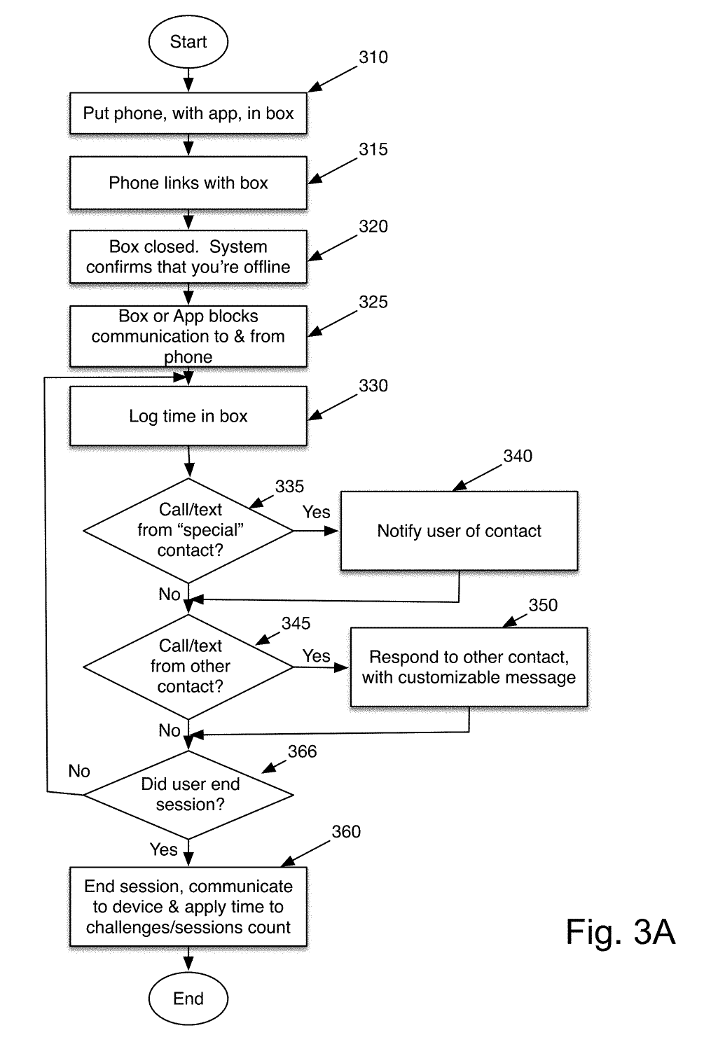

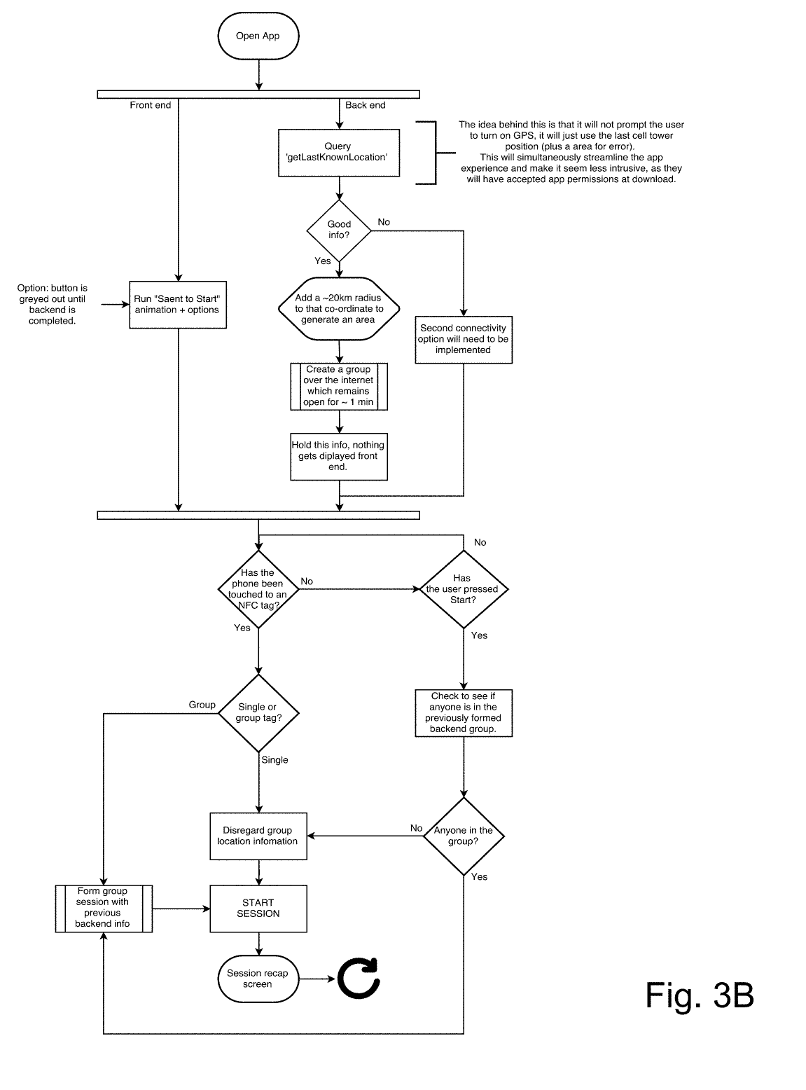

FIG. 3A describes one embodiment of the process, from placing the mobile device in the Box, to ending the session. FIG. 3B illustrates one embodiment of the application connectivity, which creates sessions.

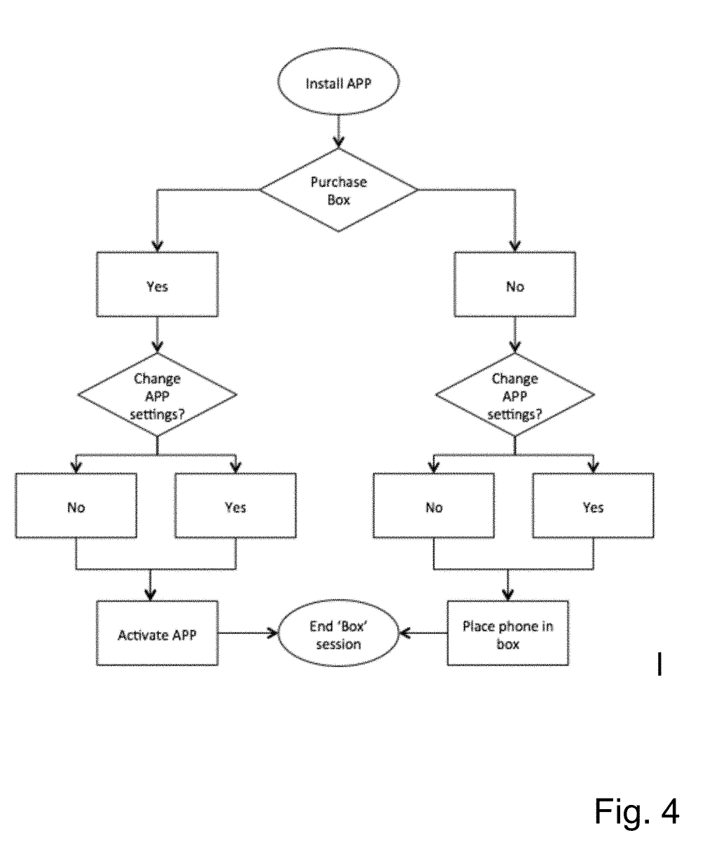

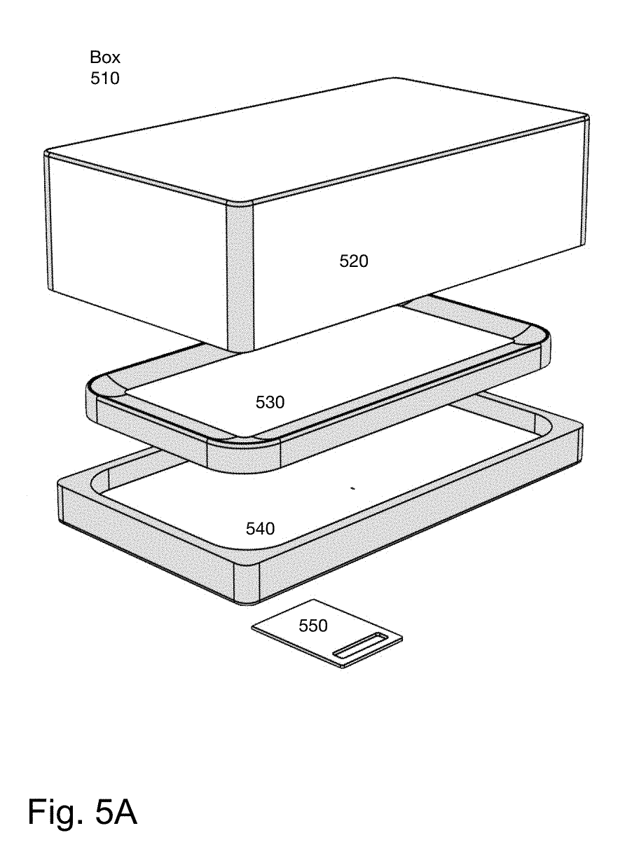

FIG. 4 illustrates the optional integration of the Box with a productivity application such as the one described in co-pending application PCT/US2016/041198, which is incorporated by reference. Of course, though these are shown as flowcharts, in one embodiment it is implemented as an interrupt-driven system, and the ordering of the individual elements is arbitrary unless they depend on each other.

In addition, the mobile app might function as a standalone “hub” for device-related stats and challenges, so that even friends without a physical Box can send challenges to others and vice versa, as well as earn points (e.g., “Try to keep your phone in airplane mode from 9 pm-9 am”).

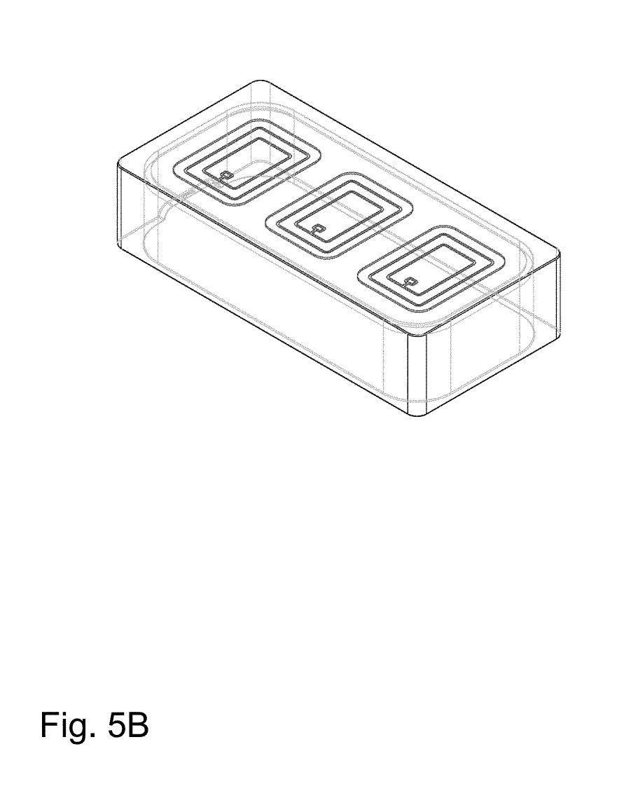

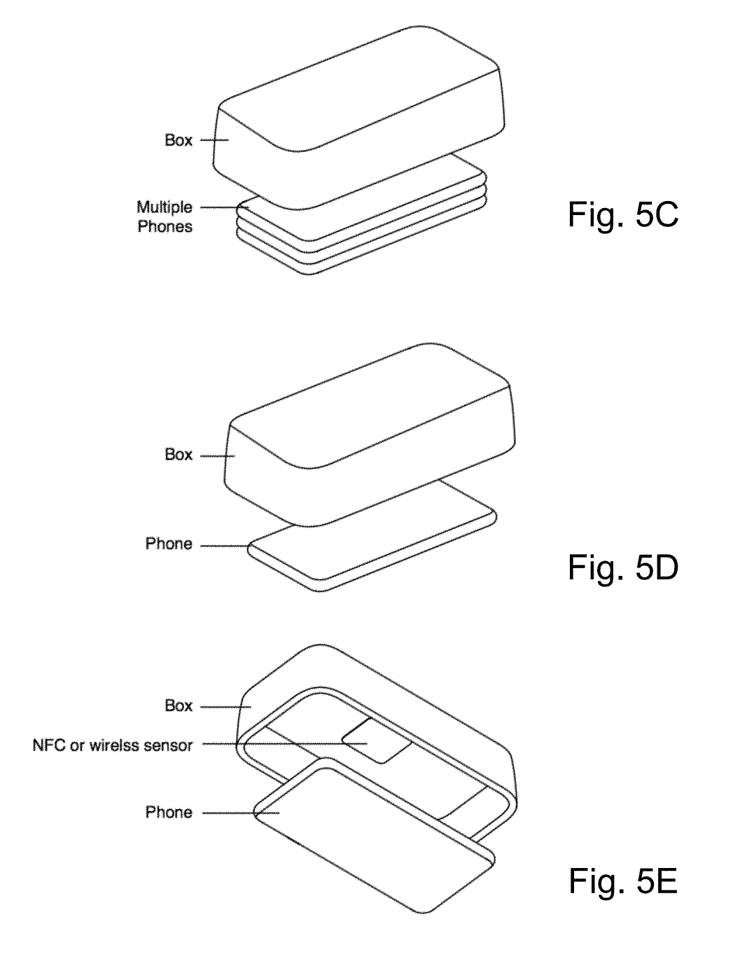

FIG. 5A illustrates one embodiment of the Box. The Box 510 includes a Box Top 520, which may be made of native woods or environmentally friendly materials. It may include a cradle 530 with an NFC chip, and a timber box bottom 540. The Box may include a craftsman's mark 550.

The Box can be custom-made, not only for different types of devices, but also for different volumes (e.g., there may be a large box for a meeting room, or a family, that holds multiple devices). In one embodiment, when integrated with a productivity system, there may be extra points and rewards on the system for putting your device in The Box during a (focus) session.

FIG. 5B illustrates another embodiment of the Box, which is simpler. The simpler embodiment includes simply the top portion, which is placed over the mobile device. In this illustration the NFC system is shown in outline. These elements would not be externally visible, in one embodiment. At its simplest, the Box includes only an NFC sensor, which is used to trigger the application in the mobile device.

FIGS. 5C and 5D illustrate the simple embodiment of the Box in two use cases. FIG. 5C illustrates using the Box for multiple phones, while FIG. 5D illustrates the box with one phone. FIG. 5E illustrates the positioning of a single sensor, on the inside top of the Box.

In one embodiment, the system may enable the user to receive and complete personalized Challenges from the platform (e.g., “Don't use your device after 9 pm for better sleep”).

In one embodiment, the system may enable a user to receive and complete Challenges from friends (e.g., “don't use your phone for the next hour while we have dinner”).

In one embodiment, Connection of the log to third party applications and services, for example, your Calendar (to encourage use of The Box during a meeting), Stick (lose money if you don't manage to keep your phone in), Foursquare (receive a special deal if you leave your device in The Box during your dinner). Communication to social networks and/or friends (e.g., “I'm not available right now as my device is in The Box”). Insights and reports within the companion app(s) on your device usage.

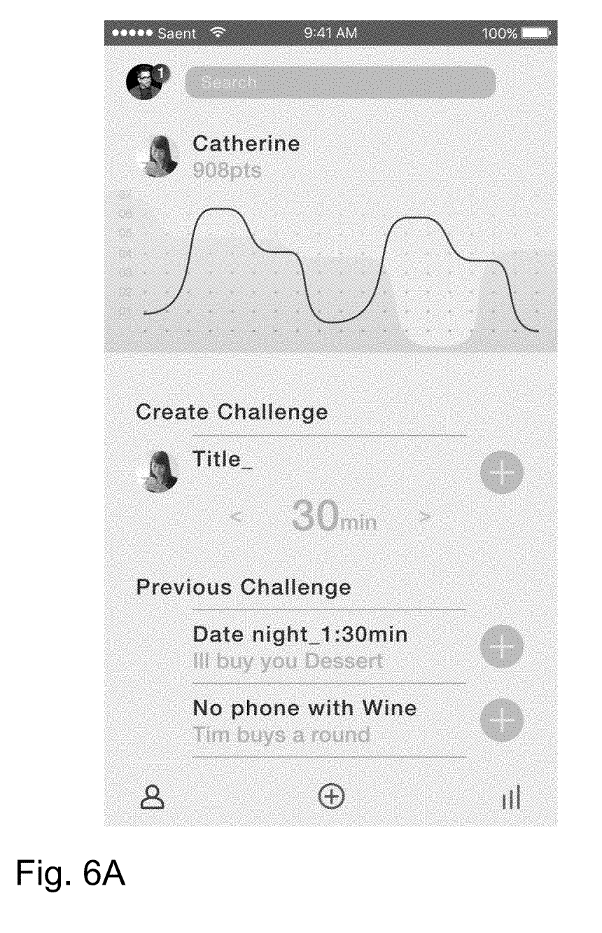

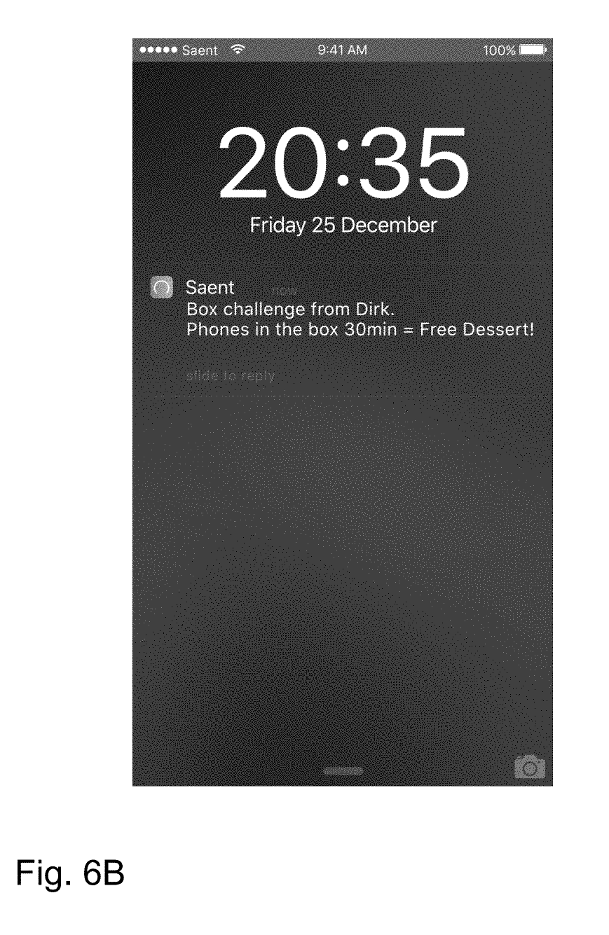

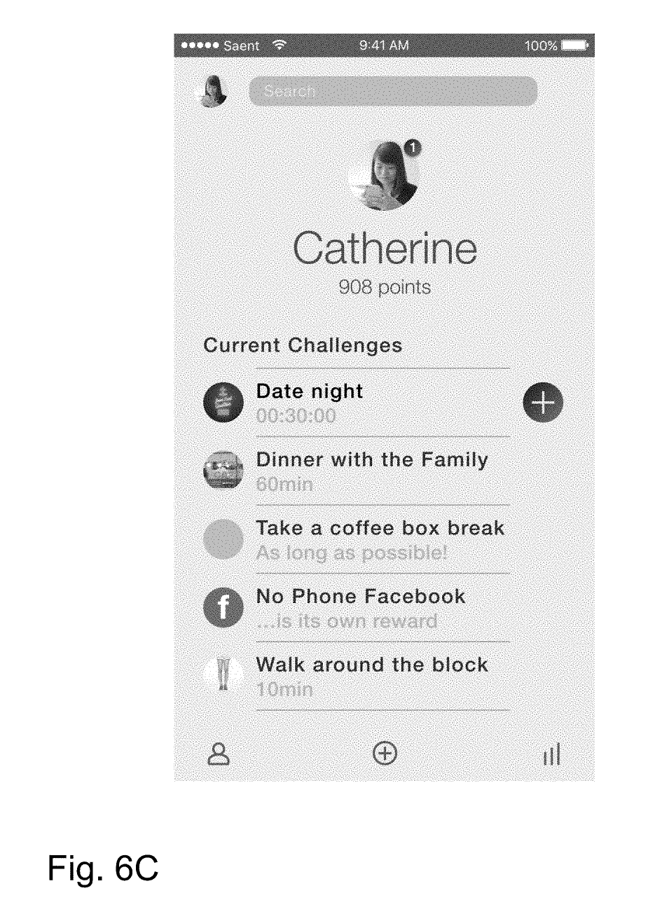

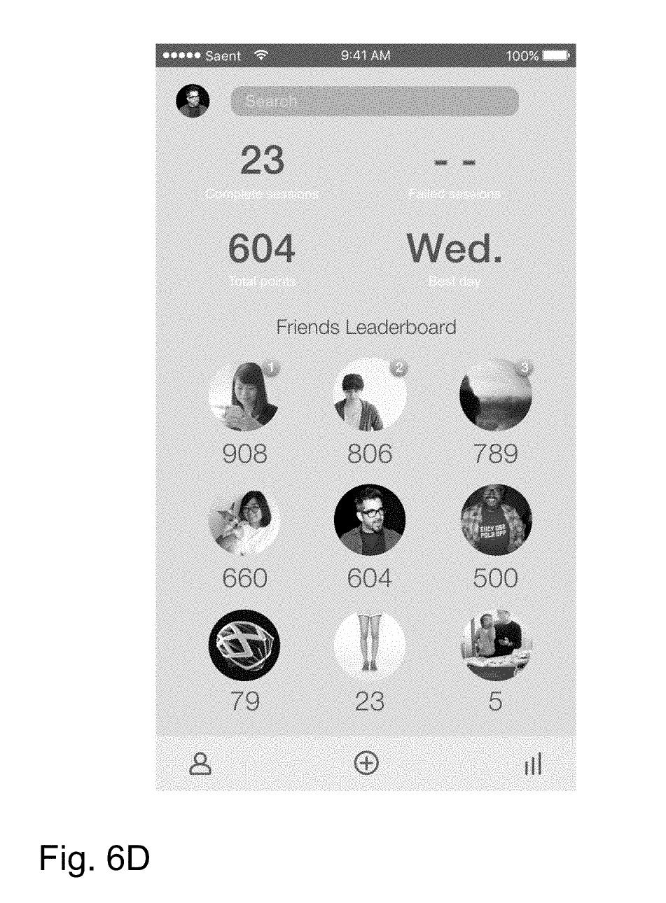

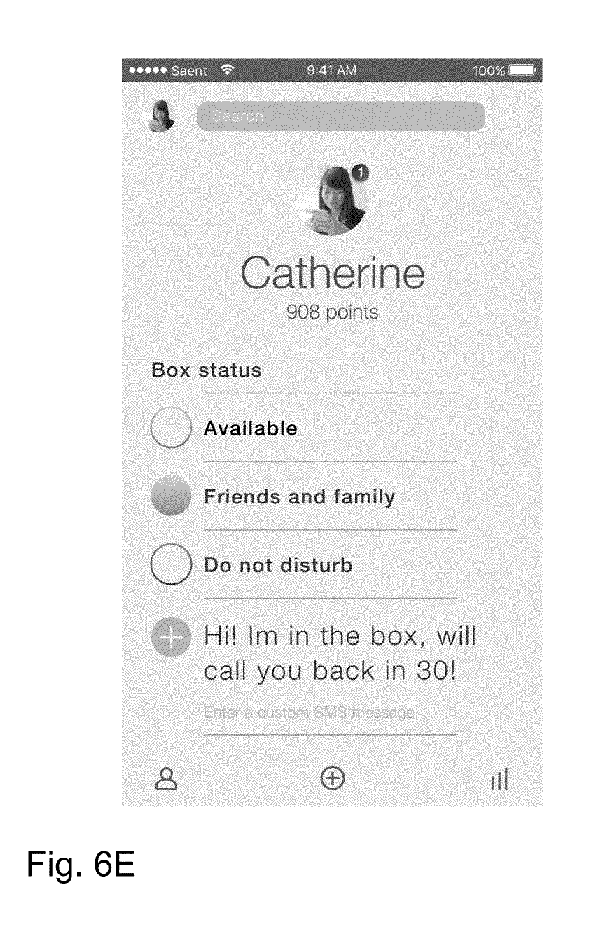

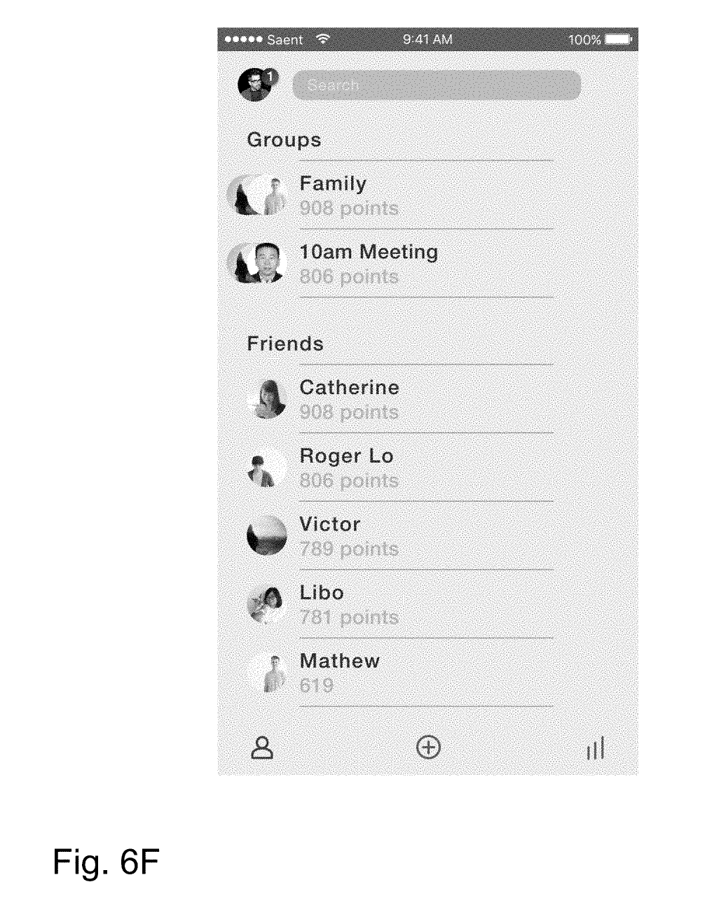

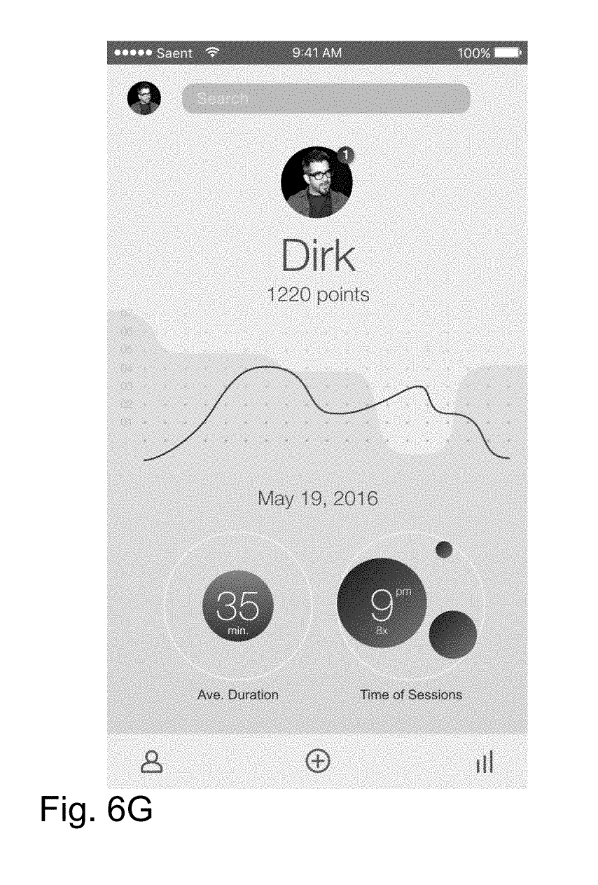

FIG. 6A-G are user interface figures of embodiments of an application associated with the Box. FIG. 6A shows one embodiment the challenge screen, where the user may create a new challenge and see past challenges. FIG. 6B shows one embodiment of a notice screen, when the user receives a challenge. FIG. 6C shows one embodiment of the list of challenges for the user, including one new challenge. FIG. 6D shows one embodiment of the results for the user, including their points and the points of people in their groups. FIG. 6E shows one embodiment of the setting for box status. This defines what occurs if the user gets a call or text message, while their device is in the Box. In one embodiment, in addition to selecting “groups,” the user may select individual messages for individual connections. FIG. 6F shows one embodiment of the user's groups, with which the user may compete or for which the user may set different Box notification rules. FIG. 6F also shows the user's friends. FIG. 6G illustrates one embodiment of the user's results, showing the average duration and time of day for the use of the box.

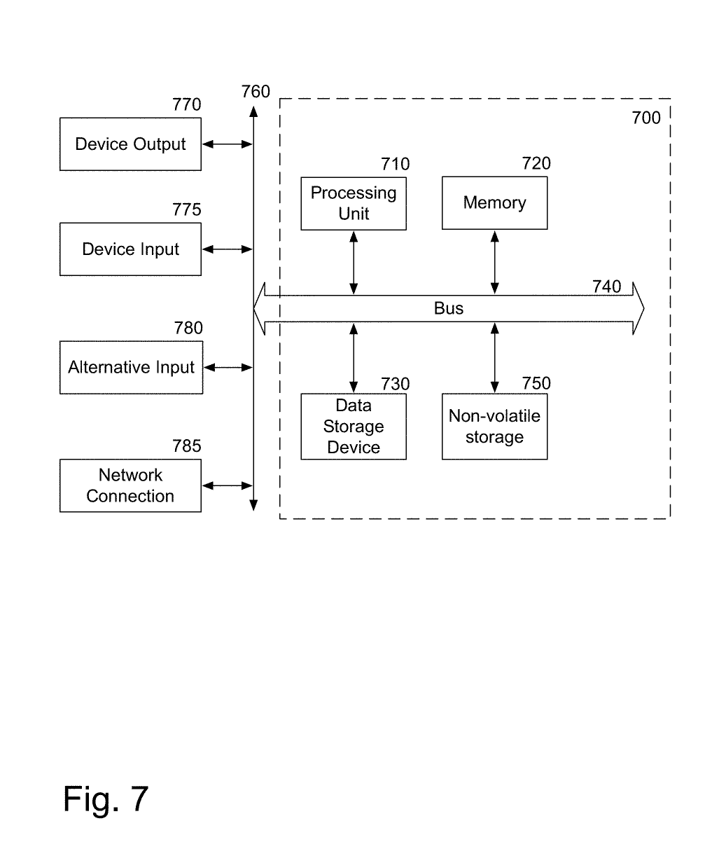

FIG. 7 is a block diagram of one embodiment of a computer system that may be used with the present invention. It will be apparent to those of ordinary skill in the art, however that other alternative systems of various system architectures may also be used.

The data processing system illustrated in FIG. 7 includes a bus or other internal communication means 740 for communicating information, and a processing unit 710 coupled to the bus 740 for processing information. The processing unit 710 may be a central processing unit (CPU), a digital signal processor (DSP), or another type of processing unit 710.

The system further includes, in one embodiment, a random access memory (RAM) or other volatile storage device 720 (referred to as memory), coupled to bus 740 for storing information and instructions to be executed by processor 710. Main memory 720 may also be used for storing temporary variables or other intermediate information during execution of instructions by processing unit 710.

The system also comprises in one embodiment a read only memory (ROM) 750 and/or static storage device 750 coupled to bus 740 for storing static information and instructions for processor 710. In one embodiment, the system also includes a data storage device 730 such as a magnetic disk or optical disk and its corresponding disk drive, or Flash memory or other storage which is capable of storing data when no power is supplied to the system. Data storage device 730 in one embodiment is coupled to bus 740 for storing information and instructions.

The system may further be coupled to an output device 770, such as a cathode ray tube (CRT) or a liquid crystal display (LCD) coupled to bus 740 through bus 760 for outputting information. The output device 770 may be a visual output device, an audio output device, and/or tactile output device (e.g. vibrations, etc.)

An input device 775 may be coupled to the bus 760. The input device 775 may be an alphanumeric input device, such as a keyboard including alphanumeric and other keys, for enabling a user to communicate information and command selections to processing unit 710. An additional user input device 780 may further be included. One such user input device 780 is cursor control device 780, such as a mouse, a trackball, stylus, cursor direction keys, or touch screen, may be coupled to bus 740 through bus 760 for communicating direction information and command selections to processing unit 710, and for controlling movement on display device 770.

Another device, which may optionally be coupled to computer system 700, is a network device 785 for accessing other nodes of a distributed system via a network. The communication device 785 may include any of a number of commercially available networking peripheral devices such as those used for coupling to an Ethernet, token ring, Internet, or wide area network, personal area network, wireless network or other method of accessing other devices. The communication device 785 may further be a null-modem connection, or any other mechanism that provides connectivity between the computer system 700 and the outside world.

Note that any or all of the components of this system illustrated in FIG. 7 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 720, mass storage device 730, or other storage medium locally or remotely accessible to processor 710.

It will be apparent to those of ordinary skill in the art that the system, method, and process described herein can be implemented as software stored in main memory 720 or read only memory 750 and executed by processor 710. This control logic or software may also be resident on an article of manufacture comprising a computer readable medium having computer readable program code embodied therein and being readable by the mass storage device 730 and for causing the processor 710 to operate in accordance with the methods and teachings herein.

The present invention may also be embodied in a handheld or portable device containing a subset of the computer hardware components described above. For example, the handheld device may be configured to contain only the bus 740, the processor 710, and memory 750 and/or 720.

The handheld device may be configured to include a set of buttons or input signaling components with which a user may select from a set of available options. These could be considered input device #1 775 or input device #2 780. The handheld device may also be configured to include an output device 770 such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a kiosk or a vehicle. For example, the appliance may include a processing unit 710, a data storage device 730, a bus 740, and memory 720, and no input/output mechanisms, or only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism. In one embodiment, the device may not provide any direct input/output signals, but may be configured and accessed through a website or other network-based connection through network device 785.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 710. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A box to encourage a user not to use a mobile device comprising:
a space to receive the mobile device;
a communication logic and wireless technology, selected from near field communication technology (NFC) and personal area network (PAN) technology, to establish a communication between the mobile device and the box;
a blocking mechanism to block the mobile device from alerting the user;
wherein a time the mobile device is in the box is logged.

2. The box of claim 1, further comprising:
a triggering logic to trigger an application on the mobile device when the mobile device is placed in the box, wherein the box communicates with the application on the mobile device, using the communication logic and wireless technology

3. The box of claim 1, wherein the blocking a signal blocking technology to control the phones incoming & outgoing signals and communication.

4. The box of claim 1, wherein the blocking mechanism comprises setting the mobile device to a do-not-disturb mode where an application moderates the outgoing signals the mobile device creates.

5. The box of claim 1, wherein the blocking mechanism comprises activating an application on the mobile device to take over notifications from the mobile device.

6. The box of claim 5, wherein the application on the mobile device moderates core functions of the mobile device, such as phone, messaging, and notifications.

7. The box of claim 1, further comprising:
a communication logic to receive an interaction configuration from the mobile device, enabling overriding of the blocking in specific instances.

8. The box of claim 7, wherein the specific instances comprise identified individuals attempting to contact the user.

9. The box of claim 7, wherein parties contacting the user may assigned one of a variety responses, which are automatically provided to such parties.

10. The box of claim 1, further comprising:
the communication logic to communicate with a challenge system enabling the user to compete in challenges.

11. The box of claim 1, further comprising:
the communication logic to communicate with a third party system, the third party system providing incentives or rewards for using the box.

12. The box of claim 1, wherein the space is customized to receive the mobile device, selected from among: a mobile phone MP3 player, personal gaming device, personal computer, and VR googles.

13. The box o claim 1, wherein the time inside the box is logged using . using an internal clock of the mobile device.
